(19) United States
(12) Patent Application Publication
(10) Pub. No.: US 2021/0336487 A1
(43) Pub. Date: Oct. 28, 2021

(54) POWER RECEIVING DEVICE AND POWER TRANSMISSION DEVICE

(71) Applicant: DENSO CORPORATION, Kariya-city (JP)

(72) Inventors: Norihito KIMURA, Nisshin-city (JP); Eisuke TAKAHASHI, Kariya-city (JP); Masaki KANESAKI, Kariya-city (JP); Nobuhisa YAMAGUCHI, Kariya-city (JP)

(73) Assignee: DENSO CORPORATION, Kariya-city (JP)

(21) Appl. No.: 17/368,990

(22) Filed: Jul. 7, 2021

Related U.S. Application Data
(63) Continuation of application No. PCT/JP2019/051013, filed on Dec. 25, 2019.

(30) Foreign Application Priority Data
Jan. 8, 2019 (JP) 2019-001298

(51) Int. Cl. H02J 50/12; B60L 53/12; H02J 50/40; H02J 50/90

(52) U.S. Cl. CPC H02J 50/12; H02J 50/90; H02J 50/40; B60L 53/12

(57) ABSTRACT

A power receiving device installable to a vehicle and included in a contactless power supply system for supplying power in a contactless manner between the power receiving device and a power transmission device installable on a road includes: polyphase receiver coils having at least three phases; an iron core that provides magnetic flux coupling between the receiver coils for the respective phases; and receiver capacitors connected on a one-to-one basis to the receiver coils for the respective phases. The receiver coils for the respective phases are arranged to have inter-coil distances between the receiver coils, with at least one of the inter-coil distances different from the other inter-coil distances. The receiver capacitors have capacitances set based on the inter-coil distances.

### CROSS-REFERENCE TO RELATED APPLICATION

This application is the U.S. bypass application of International Application No. PCT/JP2019/051013, filed on Dec. 25, 2019, which designated the U.S. and claims priority to Japanese Patent Applications No. 2019-001298 filed on Jan. 8, 2019, the contents of both of which are incorporated herein by reference.

### TECHNICAL FIELD

The present disclosure relates to a power transmission device and a power receiving device included in a contactless power supply system that allows the power transmission device to transmit power to the power receiving device in a contactless manner.

### BACKGROUND

Systems that supply power to secondary batteries incorporated in, for example, electric vehicles include contactless power supply systems that supply power in a contactless manner. A contactless power supply system includes an inverter circuit in a power transmission device, and the inverter circuit supplies alternating current (AC) power to a transmitter (transmitting coil). The transmitter then transmits power in a contactless manner to a receiver (receiving coil) on a vehicle, and the receiver supplies power to a secondary battery.

### SUMMARY

A first aspect of the present disclosure is a power receiving device installable to a vehicle and included in a contactless power supply system for supplying power in a contactless manner between the power receiving device and a power transmission device installable on a road. The power receiving device includes: polyphase receiver coils having at least three phases; an iron core that provides magnetic flux coupling between the receiver coils for the respective phases; and receiver capacitors connected on a one-to-one basis to the receiver coils for the respective phases. The receiver coils for the respective phases are arranged to have inter-coil distances between the receiver coils, with at least one of the inter-coil distances different from the other inter-coil distances. The receiver capacitors have capacitances set based on the inter-coil distances.

A second aspect of the present disclosure is a power transmission device installable on a road and included in a contactless power supply system for supplying power in a contactless manner between the power transmission device and a power receiving device installable to a vehicle. The power transmission device includes: polyphase source coils having at least three phases; an iron core that provides magnetic flux coupling between the source coils for the respective phases; and source capacitors connected on a one-to-one basis to the source coils for the respective phases. The source coils for the respective phases are arranged to have inter-coil distances between the source coils, with at least one of the inter-coil distances different from the other inter-coil distances. The source capacitors have capacitances set based on the inter-coil distances.

### BRIEF DESCRIPTION OF THE DRAWINGS

The above features of the present disclosure will be made clearer by the following detailed description, given referring to the appended drawings. In the accompanying drawings:

FIG. 1 is a circuit diagram illustrating the electrical structure of a contactless power supply system;

FIG. 2 is a perspective view of transmitting coils and receiving coils;

FIG. 3 is a perspective view of the transmitting coils and the receiving coils;

FIG. 4 is a graph illustrating differences in inductance among phases; and

FIG. 5 is a graph illustrating capacitances.

### DETAILED DESCRIPTION OF THE PREFERRED EMBODIMENTS

A three-phase power supply system has been recently proposed to increase effective power (e.g., JP 2011-167020 A). The power supply system described in JP 2011-167020 A includes a core for each phase, and the cores are shifted from each other. This arrangement can prevent magnetic coupling among the phases, reducing the mutual inductances. Thus, the balance between the three phases can be adjusted to provide three-phase power supply in a stable manner.

However, with different cores provided for different phases and spaced from each other to prevent magnetic coupling, the transmitter and the receiver will increase in size.

The present disclosure has been made in view of the above problem, and a main object of the disclosure is to provide a power transmission device and a power receiving device that improve power supply efficiency and enable downsizing.

A first aspect of the present disclosure is a power receiving device installable to a vehicle and included in a contactless power supply system for supplying power in a contactless manner between the power receiving device and a power transmission device installable on a road. The power receiving device includes: polyphase receiver coils having at least three phases; an iron core that provides magnetic flux coupling between the receiver coils for the respective phases; and receiver capacitors connected on a one-to-one basis to the receiver coils for the respective phases. The receiver coils for the respective phases are arranged to have inter-coil distances between the receiver coils, with at least one of the inter-coil distances different from the other inter-coil distances. The receiver capacitors have capacitances set based on the inter-coil distances.

The iron core is installed so as to provide magnetic flux coupling between the receiver coils for the respective phases. This arrangement enables downsizing compared with a configuration in which an iron core is provided for each coil, with the coils spaced from each other to prevent magnetic flux coupling.

Meanwhile, the mutual inductances will cause variations in the inductances of the receiver coils. In the above structure, however, the capacitances of the receiver capacitors are set based on the inter-coil distances. The setting can reduce the variations in the inductances of the receiver coils. This enables power supply with a high degree of efficiency.

A second aspect of the present disclosure is a power transmission device installable on a road and included in a contactless power supply system for supplying power in a contactless manner between the power transmission device and a power receiving device installable to a vehicle. The power transmission device includes: polyphase source coils having at least three phases; an iron core that provides magnetic flux coupling between the source coils for the respective phases; and source capacitors connected on a one-to-one basis to the source coils for the respective phases. The source coils for the respective phases are arranged to have inter-coil distances between the source coils, with at least one of the inter-coil distances different from the other inter-coil distances. The source capacitors have capacitances set based on the inter-coil distances.

The iron core is installed so as to provide magnetic flux coupling between the source coils for the respective phases. This arrangement enables downsizing compared with a configuration in which an iron core is provided for each coil, the coils spaced from each other to prevent magnetic flux coupling.

Meanwhile, the mutual inductances will cause variations in the inductances of the source coils. In the above structure, however, the capacitances of the source capacitors are set based on the inter-coil distances. The setting can reduce the variations in the inductances of the source coils. This enables power supply with a high degree of efficiency.

An embodiment will be described below with reference to the drawings. A contactless power supply system 10 in the present embodiment includes a power transmission device 20 that is supplied with power from a commercial power supply 11 and transmits the power in a contactless manner, and a power receiving device 30 that receives power from the power transmission device 20 in a contactless manner. The power transmission device 20 is buried in a ground surface such as a road traveled by vehicles (e.g., an expressway) or a vehicle parking space. The power receiving device 30 is mounted on a vehicle such as an electric vehicle or a hybrid vehicle, and outputs power to an on-vehicle battery 12 to charge the on-vehicle battery 12.

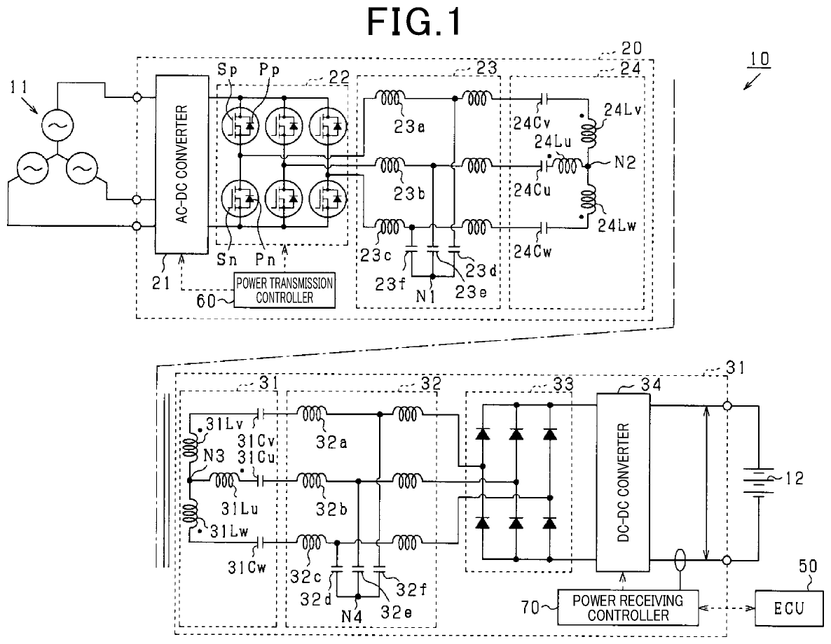

FIG. 1 illustrates the electrical structure of the contactless power supply system 10 in the present embodiment. The power transmission device 20 of the contactless power supply system 10 is connected to the commercial power supply 11 and feeds the power transmission device 20 with AC power supplied from the commercial power supply 11. The power receiving device 30 of the contactless power supply system 10 is connected to the on-vehicle battery 12 and outputs power from the power receiving device 30 to charge the on-vehicle battery 12. The power transmission device 20 and the power receiving device 30 each include three-phase (U-phase, V-phase, W-phase) coils to enable three-phase power supply.

The power transmission device 20 will now be described. The power transmission device 20 includes an AC-DC converter 21 connected to the commercial power supply 11, an inverter circuit 22 connected to the AC-DC converter 21, a power transmission filter circuit 23 connected to the inverter circuit 22, and a power transmission resonance circuit 24 connected to the power transmission filter circuit 23.

The AC-DC converter 21 converts AC power supplied from the commercial power supply 11 into direct current (DC) power.

The inverter circuit 22 converts DC power supplied from the AC-DC converter 21 into AC power with a predetermined frequency. The inverter circuit 22 is a three-phase inverter that converts DC power into three-phase, or U-phase, V-phase, and W-phase, AC power.

The inverter circuit 22 is connected to the AC-DC converter 21. More specifically, the positive electrode terminal of the AC-DC converter 21 is connected to the higher potential terminal of the inverter circuit 22. The negative electrode terminal of the AC-DC converter 21 is connected to the lower potential terminal of the inverter circuit 22.

The inverter circuit 22 is a full-bridge circuit including as many upper and lower arms as the three phases. Each arm has a switching element that is turned on or off to regulate the current in the corresponding phase.

In detail, the inverter circuit 22 includes, for each of the three phases, or U-phase, V-phase, and W-phase, a series-connection body of an upper arm switch Sp and a lower arm switch Sn serving as switching elements. In the present embodiment, the upper arm switch Sp and the lower arm switch Sn for each phase are voltage-controlled semiconductor switching elements, or more specifically, IGBTs. Note that MOSFETs may also be used. The upper arm switch Sp and the lower arm switch Sn for each phase are respectively connected to antiparallel freewheel diodes (reflux diodes) Pp and Pn.

The higher potential terminal (collector) of the upper arm switch Sp for each phase is connected to the positive electrode terminal of the AC-DC converter 21. The lower potential terminal (emitter) of the lower arm switch Sn for each phase is connected to the negative electrode terminal (ground) of the AC-DC converter 21. The connection point between the upper arm switch Sp and the lower arm switch Sn for each phase is connected to the power transmission filter circuit 23.

More specifically, the connection point between the upper arm switch Sp and the lower arm switch Sn for U-phase is connected through the power transmission filter circuit 23 to a source resonant coil 24Lu for U-phase in the power transmission resonance circuit 24. Likewise, the connection point between the upper arm switch Sp and the lower arm switch Sn for V-phase is connected through the power transmission filter circuit 23 to a source resonant coil 24Lu for V-phase in the power transmission resonance circuit 24. Likewise, the connection point between the upper arm switch Sp and the lower arm switch Sn for W-phase is connected through the power transmission filter circuit 23 to a source resonant coil 24Lw for W-phase in the power transmission resonance circuit 24.

The power transmission filter circuit 23 is a circuit that filters out AC power received from the inverter circuit 22 except AC power in a predetermined frequency band. The power transmission filter circuit 23 is a band-pass filter. The power transmission filter circuit 23 includes series-connection bodies 23a to 23c corresponding to the respective phases and each having two reactors connected in series. The power transmission filter circuit 23 also includes capacitors 23d to 23f each having one end connected to the connection point of the corresponding one of the series-connection bodies 23a to 23c. The other ends of the capacitors 23d to 23f are connected at a connection point (neutral point) N1. More specifically, the other ends of the capacitors 23d to 23f are connected to each other.

The power transmission resonance circuit 24 is a circuit that outputs AC power received from the power transmission filter circuit 23 to the power receiving device 30. The power transmission resonance circuit 24 includes an LC resonance circuit for each phase, and the LC resonance circuits are obtained by connecting the source resonant coils 24Lu, 24Lv, and 24Lw as source coils in series with source resonant capacitors 24Cu, 24Cv, and 24Cw as source capacitors, respectively. One end of each LC resonance circuit is connected to the power transmission filter circuit 23, and the other end is connected to a neutral point N2.

The power receiving device 30 includes a power reception resonance circuit 31 that is supplied with power from the power transmission resonance circuit 24, a power reception filter circuit 32 connected to the power reception resonance circuit 31, a rectification circuit 33 connected to the power reception filter circuit 32, and a DC-DC converter 34 connected to the rectification circuit 33.

The power reception resonance circuit 31 is a circuit that receives power from the power transmission resonance circuit 24 in a contactless manner and outputs the power to the power reception filter circuit 32. The power reception resonance circuit 31 has the same structure as the power transmission resonance circuit 24 and may magnetically resonate with the power transmission resonance circuit 24.

More specifically, the power reception resonance circuit 31 includes an LC resonance circuit for each phase, and the LC resonance circuits are obtained by connecting receiver resonant coils 31Lu, 31Lv, and 31Lw as receiver coils in series with receiver resonant capacitors 31Cu, 31Cv, and 31Cw as receiver capacitors, respectively. One end of each LC resonance circuit is connected to a neutral point N3, and the other end is connected to the power reception filter circuit 32. The power reception resonance circuit 31 and the power transmission resonance circuit 24 are set to have the same resonance frequency.

The power reception filter circuit 32 filters out AC power received from the power reception resonance circuit 31 except AC power in a predetermined frequency band. The power reception filter circuit 32 is a band-pass filter. The power reception filter circuit 32 includes series-connection bodies 32a to 32c corresponding to the respective phases and each having two reactors connected in series. The power reception filter circuit 32 also includes capacitors 32d to 32f each having one end connected to the connection point of the corresponding one of the series-connection bodies 32a to 32c. The other ends of the capacitors 32d to 32f are connected at a connection point (neutral point) N4. More specifically, the other ends of the capacitors 32d to 32f are connected to each other.

The rectification circuit 33 is a circuit that full-wave rectifies AC power. Although the rectification circuit 33 in the present embodiment is a full-wave rectifier circuit including a diode bridge, a synchronous rectifier circuit including six switching elements (e.g., MOSFETs) may be used.

The DC-DC converter 34 transforms and outputs DC power received from the rectification circuit 33 to the on-vehicle battery 12. The on-vehicle battery 12 is charged with the DC power received from the DC-DC converter 34.

The power transmission device 20 also includes a power transmission controller 60 that controls the power transmission device 20. The power receiving device 30 also includes a power reception controller 70 that controls the power receiving device 30. The power transmission controller 60 controls the AC-DC converter 21 and the inverter circuit 22. The power reception controller 70 controls the rectification circuit 33 and the DC-DC converter 34. The vehicle includes an electronic control unit (ECU) 50 that instructs the power reception controller 70 to enable contactless power supply during the traveling of the vehicle, charging the on-vehicle battery 12.

In this structure, when the relative position between the power transmission device 20 and the power receiving device 30 allows magnetic resonance, the input of AC power to the source resonant capacitors 24Cu, 24Cv, and 24Cw causes magnetic resonance between the source resonant capacitors 24Cu, 24Cv, and 24Cw and the receiver resonant capacitors 31Cu, 31Cv, and 31Cw. As a result, the power receiving device 30 receives part of the energy from the power transmission device 20. That is, AC power is received. For convenience of explanation, the present embodiment will be described on the assumption that the relative position between the power transmission device 20 and the power receiving device 30 allows magnetic resonance.

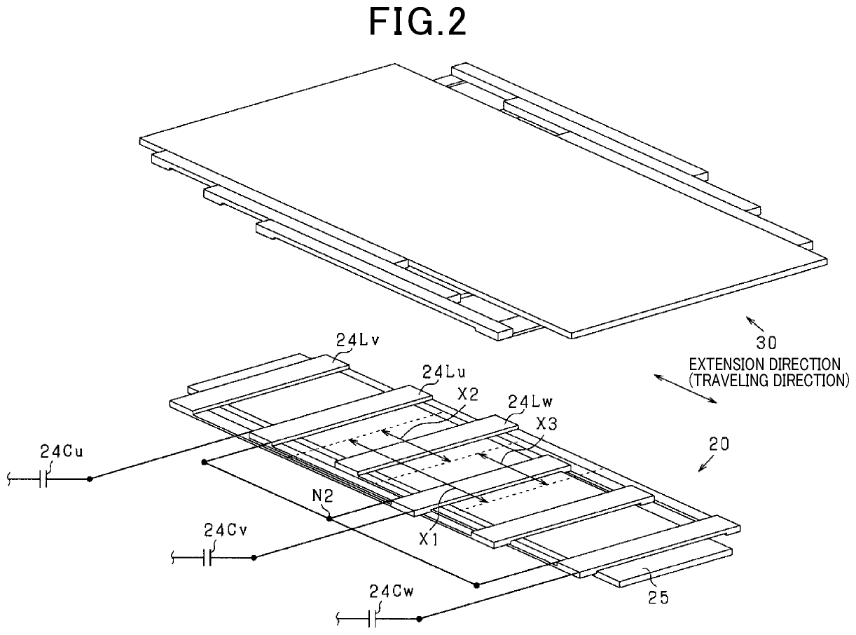

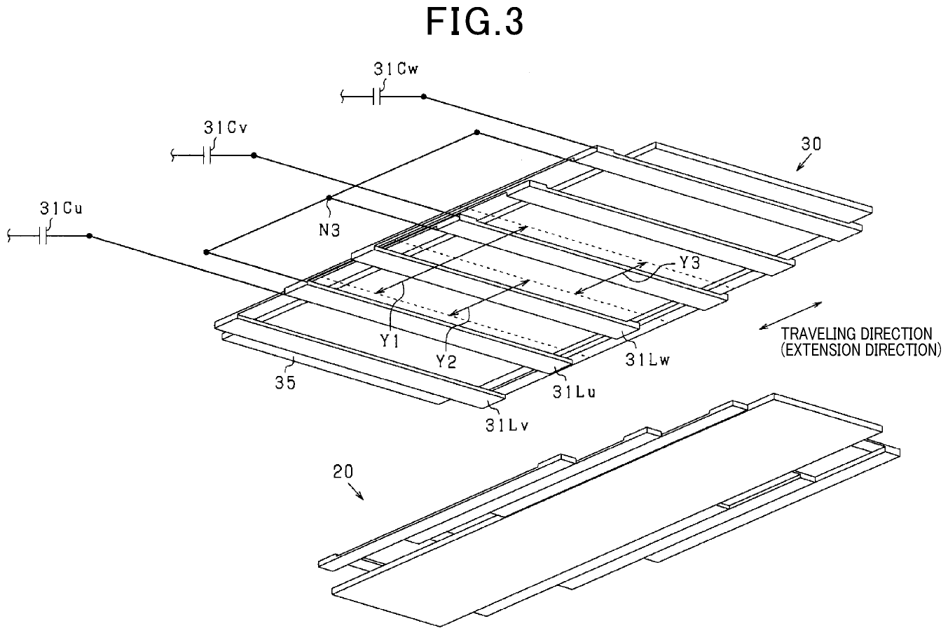

The mechanical structures of the source resonant coils 24Lu, 24Lv, and 24Lw and the receiver resonant coils 31Lu, 31Lv, and 31Lw will now be described. FIG. 2 is a perspective view of the source resonant coils 24Lu, 24Lv, and 24Lw and the receiver resonant coils 31Lu, 31Lv, and 31Lw as viewed from above (the vehicle, the receiver side). FIG. 3 is a perspective view from below (the road, the source side).

As shown in FIG. 2, the source resonant coils 24Lu, 24Lu, and 24Lw are rectangular planar coils formed by winding wires (e.g., Litz wires) in a plane. The source resonant coils 24Lu, 24Lu, and 24Lw formed each have the shape of a loop. The source resonant coils 24Lu, 24Lv, and 24Lw have the same shape and the same number of turns. The source resonant coils 24Lu, 24Lu, and 24Lw are each longitudinally symmetrical. Likewise, the source resonant coils 24Lu, 24Lv, and 24Lw are transversely symmetrical.

The source resonant coils 24Lu, 24Lv, and 24Lw are placed and fixed on a ferrite core 25 serving as an iron core. In detail, the ferrite core 25 is formed as a rectangular plate and placed with its longitudinal direction corresponding to the extension direction of the road. The ferrite core 25 is also placed with its transverse direction corresponding to the width direction of the road, and its surface parallel to the road surface. On the surface of the ferrite core 25, the source resonant coils 24Lu, 24Lv, and 24Lw are arranged in the longitudinal direction. In this state, the source resonant coils 24Lu, 24Lv, and 24Lw are placed above the ferrite core 25, that is, nearer to the vehicle than the ferrite core 25 is.

The source resonant coils 24Lu, 24Lv, and 24Lw are shifted from each other in the longitudinal direction on the ferrite core 25. More specifically, the area surrounded by each of the source resonant coils 24Lu, 24Lv, and 24Lw overlaps the areas surrounded by the others of the source resonant coils 24Lu, 24Lv, and 24Lw. In this state, the source resonant coils 24Lu, 24Lv, and 24Lw are arranged at regular intervals in the longitudinal direction. More specifically, they are each shifted by an electrical angle of 120°. In the present embodiment, the source resonant coil 24Lu is placed at the longitudinal center, and the source resonant coils 24Lv and 24Lw are placed on both sides of the source resonant coil 24Lu in the longitudinal direction.

The receiver resonant coils 31Lu, 31Lv, and 31Lw will now be described. The receiver resonant coils 31Lu, 31Lv, and 31Lw have substantially the same structure as the source resonant coils 24Lu, 24Lv, and 24Lw.

That is, as shown in FIG. 3, the receiver resonant coils 31Lu, 31Lv, and 31Lw are rectangular planar coils formed by winding wires (e.g., Litz wires) in a plane. The receiver resonant coils 31Lu, 31Lv, and 31Lw formed each have the shape of a loop. The receiver resonant coils 31Lu, 31Lv, and 31Lw have the same shape and the same number of turns. The receiver resonant coils 31Lu, 31Lv, and 31Lw are each longitudinally symmetrical. Likewise, the receiver resonant coils 31Lu, 31Lv, and 31Lw are transversely symmetrical.

The receiver resonant coils 31Lu, 31Lv, and 31Lw are placed and fixed on a ferrite core 35 serving as an iron core. In detail, the ferrite core 35 is formed as a rectangular plate and placed with its longitudinal direction corresponding to the traveling direction of the vehicle. The ferrite core 35 is also placed with its transverse direction corresponding to the width direction of the vehicle, and its surface parallel to the bottom surface of the vehicle. That is, the surface of the ferrite core 35 faces the road surface. On the ferrite core 35, the receiver resonant coils 31Lu, 31Lv, and 31Lw are arranged in the traveling direction (longitudinal direction). In this state, the receiver resonant coils 31Lu, 31Lv, and 31Lw are placed below the ferrite core 35, that is, nearer to the road than the ferrite core 35 is.

The receiver resonant coils 31Lu, 31Lv, and 31Lw are shifted from each other in the longitudinal direction on the ferrite core 35. More specifically, the area surrounded by each of the receiver resonant coils 31Lu, 31Lv, and 31Lw overlaps the areas surrounded by the others of the receiver resonant coils 31Lu, 31Lv, and 31Lw. In this state, the receiver resonant coils 31Lu, 31Lv, and 31Lw are arranged at regular intervals in the longitudinal direction. More specifically, they are each shifted by an electrical angle of 120°. In the present embodiment, the receiver resonant coil 31Lu is placed at the longitudinal center, and the receiver resonant coils 31Lv and 31Lw are placed on both sides of the receiver resonant coil 31Lu in the longitudinal direction.

With the source resonant coils 24Lu, 24Lw, and 24Lw arranged as described above, the ferrite core 25 causes the source resonant coils 24Lu, 24Lu, and 24Lw to magnetically couple with each other, generating mutual inductance. In this case, the source resonant coil 24Lu is at an equal distance from the source resonant coils 24Lu and 24Lw. Thus, the mutual inductance between the source resonant coil 24Lu and the source resonant coil 24Lu is equal to the mutual inductance between the source resonant coil 24Lu and the source resonant coil 24Lw.

In contrast, the source resonant coil 24Lu and the source resonant coil 24Lw have an inter-coil distance X1 between them, which is twice the distance between the source resonant coils 24Lu and 24Lv, and the distance between the source resonant coils 24Lu and 24Lw, that is, inter-coil distances X2 and X3, respectively. Thus, the mutual inductance between the source resonant coil 24Lv and the source resonant coil 24Lw is smaller than the mutual inductance between the source resonant coil 24Lu and each of the source resonant coils 24Lw and 24Lv. Note that the inter-coil distances X1 to X3 are, as shown in FIG. 2, the longitudinal distances between the centers of the source resonant coils 24Lu, 24Lv, and 24Lw.

It is well known that mutual inductance is determined by the magnetic permeability of the iron core, the distance between the coils, and the shapes and the numbers of turns of the coils. Mutual inductance is also known to be inversely proportional to the distance between the coils and the lengths of the coils, and proportional to the magnetic permeability of the iron core and the cross-sectional areas and the numbers of turns of the coils. In the present embodiment, the magnetic permeability of the iron core (the ferrite core 25) is fixed, and the source resonant coils 24Lu, 24Lv, and 24Lw have the same shape and the same number of turns. Thus, the mutual inductances between the source resonant coils 24Lu, 24Lv, and 24Lw vary in accordance with the inter-coil distances between the source resonant coils 24Lu, 24Lv, and 24Lw.

For power factor compensation (to maximize the power factor) with the mutual inductances taken into consideration, the capacitances of the source resonant capacitors 24Cu, 24Cv, and 24Cw are to satisfy formulas (1) to (4).

In the formulas, the capacitance of the source resonant capacitor 24Cu is denoted by Csu1, the capacitance of the source resonant capacitor 24Cv is denoted by Csv1, and the capacitance of the source resonant capacitor 24Cw is denoted by Csw1. In the formulas, the self-inductance of the source resonant coil 24Lu is denoted by Lu1, the self-inductance of the source resonant coil 24Lv is denoted by Lv1, and the self-inductance of the source resonant coil 24Lw is denoted by Lw1.

The mutual inductance between the source resonant coil 24Lu and the source resonant coil 24Lv is denoted by Muv1. The mutual inductance between the source resonant coil 24Lu and the source resonant coil 24Lw is denoted by Muw1. The mutual inductance between the source resonant coil 24Lv and the source resonant coil 24Lw is denoted by Mvw1. The inverter drive frequency is denoted by f, and the electrical angular frequency is denoted by ω.

$$\begin{matrix}[ Math . 1 ] & \\ Csu 1 = \frac{1}{{ω}^{2} ( L u 1 - \frac{1}{2} ( M u v 1 + M u w 1 ) )} & ( 1 ) \\ Csv 1 = \frac{1}{{ω}^{2} ( L v 1 - \frac{1}{2} ( Mvw 1 + M u v 1 ) )} & ( 2 ) \\ Csw 1 = \frac{1}{{ω}^{2} ( L w 1 - \frac{1}{2} ( Mvw 1 + Muw 1 ) )} & ( 3 ) \\ ω = 2 π f & ( 4 )\end{matrix}$$

The inverter drive frequency f is common among the coils. Thus, when the electrical resonant angular frequency is denoted by (00, the self-inductances Lu1, Lv1, and Lw1, the mutual inductances Muw1, Muv1, and Mvw1, and the capacitances Csu1, Csv1, and Csw1 are to be set so as to satisfy formula (5).

$$\begin{matrix}[ Math . 2 ] & \\ {ω}_{0} = \frac{1}{\sqrt{( \begin{matrix}L u 1 - \frac{1}{2} \\ ( M u v 1 + M u w 1 )\end{matrix} ) Csu 1}} = \frac{1}{\sqrt{( \begin{matrix}L v 1 - \frac{1}{2} \\ ( M v w 1 + M u v 1 )\end{matrix} ) Csv 1}} = \frac{1}{\sqrt{( \begin{matrix}Lw 1 - \frac{1}{2} \\ ( Mvw 1 + M u w 1 )\end{matrix} ) Csw 1}} & ( 5 )\end{matrix}$$

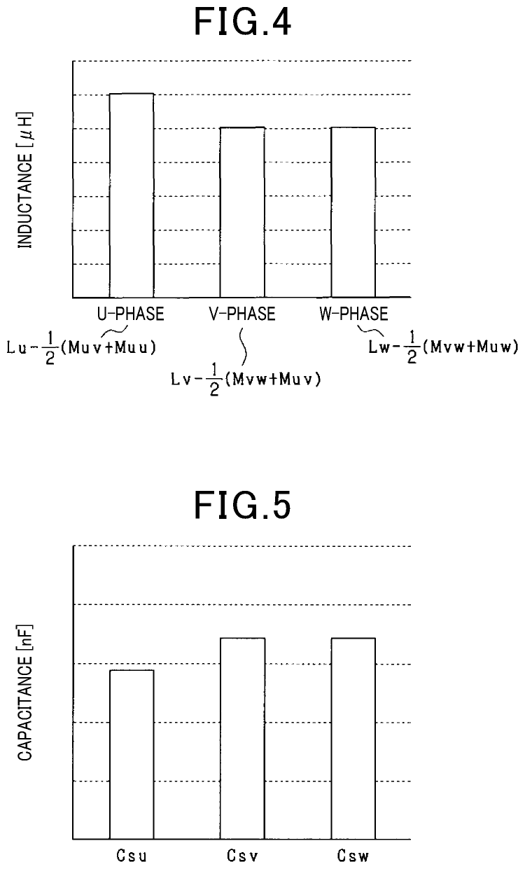

As described above, the self-inductances Lu1, Lv1, and Lw1 of the source resonant coils 24Lu, 24Lw, and 24Lw are the same. In contrast, the mutual inductance Mvw1 is, as described above, smaller than the mutual inductances Muv1 and Muw1. As a result, as shown in FIG. 4, the inductance of the source resonant coil 24Lu is greater than the inductances of the source resonant coils 24Lu and 24Lw.

Thus, to satisfy formula (5) above, the capacitances Csu1, Csv1, and Csw1 are to be set at appropriate values. That is, the capacitances Csu1, Csv1, and Csw1 are to be set based on the inter-coil distances. More specifically, so as to satisfy formula (5), the capacitance Csu1 is set at a value smaller than the capacitances Csv1 and Csw1 (see FIG. 5).

Next, the receiver structure will be described. The receiver may desirably have a structure similar to the source structure. That is, with the receiver resonant coils 31Lu, 31Lv, and 31Lw arranged as described above, the ferrite core 35 causes the receiver resonant coils 31Lu, 31Lv, and 31Lw to magnetically couple with each other, generating mutual inductance. In this case, the receiver resonant coil 31Lu is at an equal distance from the receiver resonant coils 31Lv and 31Lw. Thus, the mutual inductance between the receiver resonant coil 31Lu and the receiver resonant coil 31Lv is equal to the mutual inductance between the receiver resonant coil 31Lu and the receiver resonant coil 31Lw.

In contrast, the receiver resonant coil 31Lv and the receiver resonant coil 31Lw have an inter-coil distance Y1 between them, which is twice the distance between the receiver resonant coils 31Lu and 31Lv, and the distance between the receiver resonant coils 31Lu and 31Lw, that is, inter-coil distances Y2 and Y3, respectively. Thus, the mutual inductance between the receiver resonant coil 31Lv and the receiver resonant coil 31Lw is smaller than the mutual inductance between the receiver resonant coil 31Lu and each of the receiver resonant coils 31Lv and 31Lw. Note that the inter-coil distances Y1 to Y3 are, as shown in FIG. 3, the longitudinal distances between the centers of the receiver resonant coils 31Lu, 31Lv, and 31Lw.

In the present embodiment, the magnetic permeability of the iron core (the ferrite core 35) is fixed, and the receiver resonant coils 31Lu, 31Lv, and 31Lw have the same shape and the same number of turns. Thus, the mutual inductances between the receiver resonant coils 31Lu, 31Lv, and 31Lw vary in accordance with the inter-coil distances between the receiver resonant coils 31Lu, 31Lv, and 31Lw.

For power factor compensation (to maximize the power factor) with the mutual inductances taken into consideration, the capacitances of the receiver resonant coils 31Lu, 31Lv, and 31Lw are to satisfy formulas (6) to (9).

In the formulas, the capacitance of the receiver resonant capacitor 31Cu is denoted by Csu2, the capacitance of the receiver resonant capacitor 31Cv is denoted by Csv2, and the capacitance of the receiver resonant capacitor 31Cw is denoted by Csw2. In the formulas, the self-inductance of the receiver resonant coil 31Lu is denoted by Lu2, and the self-inductance of the receiver resonant coil 31Lv is denoted by Lv2, and the self-inductance of the receiver resonant coil 31Lw is denoted by Lw2.

The mutual inductance between the receiver resonant coil 31Lu and the receiver resonant coil 31Lv is denoted by Muv2. The mutual inductance between the receiver resonant coil 31Lu and the receiver resonant coil 31Lw is denoted by Muw2. The mutual inductance between the receiver resonant coil 31Lv and the receiver resonant coil 31Lw is denoted by Mvw2. The inverter drive frequency is denoted by f, and the electrical angular frequency is denoted by co.

$$\begin{matrix}[ Math . 3 ] & \\ Csu 2 = \frac{1}{{ω}^{2} ( Lu 2 - \frac{1}{2} ( Muv 2 + Muw 2 ) )} & ( 6 ) \\ Csv 2 = \frac{1}{{ω}^{2} ( L v 2 - \frac{1}{2} ( Mvw 2 + Muv 2 ) )} & ( 7 ) \\ Csw 1 = \frac{1}{{ω}^{2} ( L w 2 - \frac{1}{2} ( Mvw 2 + Muw 2 ) )} & ( 8 ) \\ ω = 2 π f & ( 9 )\end{matrix}$$

The inverter drive frequency f is common among the coils. Thus, when the electrical resonant angular frequency is denoted by ω0, the self-inductances Lu2, Lv2, and Lw2, the mutual inductances Muw2, Muv2, and Mvw2, and the capacitances Csu2, Csv2, and Csw2 are to be set so as to satisfy formula.

$$\begin{matrix}[ Math . 4 ] & \\ {ω}_{0} = \frac{1}{\sqrt{( \begin{matrix}L u 2 - \frac{1}{2} \\ ( M u v 2 + M u w 2 )\end{matrix} ) Csu 2}} = \frac{1}{\sqrt{( \begin{matrix}L v 2 - \frac{1}{2} \\ ( M v w 2 + M u v 2 )\end{matrix} ) Csv 2}} = \frac{1}{\sqrt{( \begin{matrix}Lw 2 - \frac{1}{2} \\ ( Mvw 2 + M u w 2 )\end{matrix} ) Csw 2}} & ( 10 )\end{matrix}$$

As described above, the self-inductances Lu2, Lv2, and Lw2 of the receiver resonant coils 31Lu, 31Lv, and 31Lw are the same. In contrast, the mutual inductance Mvw2 is, as described above, smaller than the mutual inductances Muv2 and Muw2. As a result, as shown in FIG. 4, the inductance of the receiver resonant coil 31Lu is greater than the inductances of the receiver resonant coils 31Lv and 31Lw.

Thus, to satisfy formula above, the capacitances Csu2, Csv2, and Csw2 are to be set at appropriate values. That is, the capacitances Csu2, Csv2, and Csw2 are to be set based on the inter-coil distances. More specifically, so as to satisfy formula, the capacitance Csu2 is set at a value smaller than the capacitances Csv2 and Csw2 (see FIG. 5).

Effects of the present embodiment will now be described.

The ferrite core 25 is installed so as to provide magnetic flux coupling between the source resonant coils 24Lu, 24Lv, and 24Lw for the respective phases. That is, all the source resonant coils 24Lu, 24Lv, and 24Lw for the respective phases are arranged on the single ferrite core 25. This arrangement enables downsizing compared with a configuration in which an iron core is provided for each coil, with the coils spaced from each other to prevent magnetic flux coupling.

Meanwhile, the mutual inductances Muv1, Muw1, and Mvw1 will cause variations in the inductances of the source resonant coils 24Lu, 24Lv, and 24Lw. In the above structure, however, the capacitances Csu1, Csv1, and Csw1 are set based on the inter-coil distances X1 to X3. The setting can reduce the variations in the inductances of the source resonant coils 24Lu, 24Lv, and 24Lw. This enables power supply with a high degree of efficiency.

The source resonant coils 24Lu, 24Lv, and 24Lw for the respective phases are arranged so that the inter-coil distances X1 and X2 of the inter-coil distances X1 to X3 are different from the inter-coil distance X3. This increases the arrangement flexibility of the source resonant coils 24Lu, 24Lv, and 24Lw, facilitating the design and the manufacture. More specifically, in the present embodiment, the source resonant coils 24Lu, 24Lv, and 24Lw are allowed to be arranged in the longitudinal direction.

The source resonant coils 24Lu, 24Lv, and 24Lw are arranged in the extension direction of the road and shifted from each other in the extension direction. This arrangement enables an increase in the duration of contactless power supply performed during the traveling of a vehicle, improving the efficiency. In addition, the arrangement of the source resonant coils 24Lu, 24Lv, and 24Lw in the extension direction of the road enables a reduction in the width orthogonal to the extension direction.

In this case, the mutual inductances Muv1, Muw1, and Mvw1 will vary. However, the capacitances Csu1, Csv1, and Csw1 are set based on the inter-coil distances X1 to X3. The setting can reduce the variations in the inductances of the source resonant coils 24Lu, 24Lv, and 24Lw. Thus, power is supplied in a stable manner with a high degree of efficiency.

The use of loop-shaped planar coils as the source resonant coils 24Lu, 24Lv, and 24Lw enables power supply with a high degree of efficiency. The area surrounded by each of the source resonant coils 24Lu, 24Lv, and 24Lw overlaps the areas surrounded by the others of the source resonant coils 24Lu, 24Lv, and 24Lw. This arrangement enables overall downsizing without increasing the full lengths of the source resonant coils 24Lu, 24Lv, and 24Lw in the extension direction.

Although the mutual inductances Muv1, Muw1, and Mvw1 are determined by the inter-coil distances X1 to X3 and the shapes and the numbers of turns of the source resonant coils 24Lu, 24Lv, and 24Lw, the source resonant coils 24Lu, 24Lv, and 24Lw for the respective phases have the same shape and the same number of turns. Thus, since the source resonant coils 24Lu, 24Lv, and 24Lw are arranged at regular intervals in the extension direction, the inductance of the central source resonant coil 24Lu is greater than the inductances of the other source resonant coils 24Lv and 24Lw. Accordingly, the capacitance Csu1 of the source resonant capacitor 24Cu connected to the central source resonant coil 24Lu may be set at a value smaller than the other capacitances Csv1 and Csw1 to attain the balance between the inductances in an appropriate manner. This enables three-phase power supply in a stable and efficient manner.

The ferrite core 35 is installed so as to provide magnetic flux coupling between the receiver resonant coils 31Lu, 31Lv, and 31Lw for the respective phases. That is, all the receiver resonant coils 31Lu, 31Lv, and 31Lw for the respective phases are arranged on the single ferrite core 35. This arrangement enables downsizing compared with a configuration in which an iron core is provided for each coil, with the coils spaced from each other to prevent magnetic flux coupling.

Meanwhile, the mutual inductances Muv2, Muw2, and Mvw2 will cause variations in the inductances of the receiver resonant coils 31Lu, 31Lv, and 31Lw. In the above structure, however, the capacitances Csu2, Csv2, and Csw2 are set based on the inter-coil distances Y1 to Y3. The setting can reduce the variations in the inductances of the receiver resonant coils 31Lu, 31Lv, and 31Lw. This enables power supply with a high degree of efficiency.

The receiver resonant coils 31Lu, 31Lv, and 31Lw for the respective phases are arranged so that the inter-coil distances Y1 and Y2 of the inter-coil distances Y1 to Y3 are different from the inter-coil distance Y3. This increases the arrangement flexibility of the receiver resonant coils 31Lu, 31Lv, and 31Lw, facilitating the design and the manufacture. More specifically, in the present embodiment, the receiver resonant coils 31Lu, 31Lv, and 31Lw are allowed to be arranged in the longitudinal direction.

The receiver resonant coils 31Lu, 31Lv, and 31Lw are arranged in the traveling direction of the vehicle and shifted from each other in the traveling direction. This arrangement enables an increase in the duration of contactless power supply during the traveling of the vehicle, improving the efficiency. In addition, the arrangement of the receiver resonant coils 31Lu, 31Lv, and 31Lw in the traveling direction of the vehicle enables a reduction in the width orthogonal to the traveling direction.

The use of loop-shaped planar coils as the receiver resonant coils 31Lu, 31Lv, and 31Lw enables power supply with a high degree of efficiency. The area surrounded by each of the receiver resonant coils 31Lu, 31Lv, and 31Lw overlaps the areas surrounded by the others of the receiver resonant coils 31Lu, 31Lv, and 31Lw. This arrangement enables overall downsizing without increasing the full lengths of the receiver resonant coils 31Lu, 31Lv, and 31Lw in the traveling direction.

The receiver resonant coils 31Lu, 31Lv, and 31Lw for the respective phases have the same shape and the same number of turns. Thus, since the receiver resonant coils 31Lu, 31Lv, and 31Lw are arranged at regular intervals in the traveling direction, the inductance of the central receiver resonant coil 31Lu is greater than the inductances of the other receiver resonant coils 31Lv and 31Lw. Accordingly, the capacitance Csu2 of the receiver resonant capacitor 31Cu connected to the central receiver resonant coil 31Lu may be set at a value smaller than the other capacitances Csv2 and Csw2 to attain the balance between the inductances in an appropriate manner. This enables three-phase power supply in a stable and efficient manner.

### OTHER EMBODIMENTS

It should be noted that the present disclosure is not limited to the above embodiment, but may be modified variously without departing from the scope and the spirit of the present disclosure. In the embodiments described below, the same or equivalent parts are given the same reference numerals, and will not be described repeatedly.

The source resonant coils 24Lu, 24Lw, and 24Lw in the above embodiment may have different shapes and different numbers of turns. In this case, the capacitances Csu1, Csv1, and Csw1 may be desirably set based on the inter-coil distances X1 to X3 as well as the shapes (the cross-sectional areas and the coil lengths) and the numbers of turns of the source resonant coils 24Lu, 24Lv, and 24Lw for the respective phases. This enables three-phase power supply in a stable and efficient manner.

The receiver resonant coils 31Lu, 31Lv, and 31Lw in the above embodiment may have different shapes and different numbers of turns. In this case, the capacitances Csu2, Csv2, and Csw2 may be desirably set based on the inter-coil distances Y1 to Y3 as well as the shapes (the cross-sectional areas and the coil lengths) and the numbers of turns of the receiver resonant coils 31Lu, 31Lv, and 31Lw for the respective phases. This enables three-phase power supply in a stable and efficient manner.

Although the present disclosure has been described based on the embodiments, it is to be understood that the disclosure is not limited to the embodiments and configurations. This disclosure encompasses various modifications and alterations falling within the range of equivalence. In addition, various combinations and forms as well as other combinations and forms with one, more than one, or less than one element added thereto also fall within the scope and spirit of the present disclosure.

What is claimed is:

1. A power receiving device installable to a vehicle and included in a contactless power supply system for supplying power in a contactless manner between the power receiving device and a power transmission device installable on a road, the power receiving device comprising:
polyphase receiver coils having at least three phases;
an iron core configured to provide magnetic flux coupling between the receiver coils for the respective phases; and
receiver capacitors connected on a one-to-one basis to the receiver coils for the respective phases, wherein
the receiver coils for the respective phases are arranged to have inter-coil distances between the receiver coils, with at least one of the inter-coil distances different from the other inter-coil distances, and
the receiver capacitors have capacitances set based on the inter-coil distances.

2. The power receiving device according to claim 1, wherein
the iron core is formed as a plate and placed with a surface thereof facing the road,
the receiver coils for the respective phases are arranged on the surface of the iron core, and
the receiver coils for the respective phases are arranged in a traveling direction of the vehicle and shifted from each other in the traveling direction.

3. The power receiving device according to claim 2, wherein
the receiver coils for the respective phases are loop-shaped planar coils arranged on the surface of the iron core and each surrounding an area, and the area surrounded by each of the receiver coils overlaps the areas surrounded by the others of the receiver coils.

4. The power receiving device according to claim 3, wherein
the receiver coils have three phases, and the receiver coils for the respective phases have an identical shape and an identical number of turns,
the receiver coils are arranged at regular intervals in the traveling direction, and
the receiver capacitor connected to the central coil of the receiver coils arranged in the traveling direction has a capacitance smaller than the capacitances of the other receiver capacitors.

5. The power receiving device according to claim 1, wherein
the capacitances of the receiver capacitors are set based on the inter-coil distances, and the shapes and the numbers of turns of the receiver coils for the respective phases.

6. A power transmission device installable on a road and included in a contactless power supply system for supplying power in a contactless manner between the power transmission device and a power receiving device installable to a vehicle, the power transmission device comprising:
polyphase source coils having at least three phases;
an iron core configured to provide magnetic flux coupling between the source coils for the respective phases; and
source capacitors connected on a one-to-one basis to the source coils for the respective phases, wherein
the source coils for the respective phases are arranged to have inter-coil distances between the source coils, with at least one of the inter-coil distances different from the other inter-coil distances, and
the source capacitors have capacitances set based on the inter-coil distances.

7. The power transmission device according to claim 6, wherein
the iron core is formed as a plate and placed with a surface thereof parallel to a road surface of the road,
on the surface of the iron core, the source coils for the respective phases are arranged, and
the source coils for the respective phases are arranged in an extension direction of the road and shifted from each other in the extension direction.

8. The power transmission device according to claim 7, wherein
the source coils for the respective phases are loop-shaped planar coils arranged on the surface of the iron core and each surrounding an area, and the area surrounded by each of the source coils overlaps the areas surrounded by the others of the source coils.

9. The power transmission device according to claim 8, wherein
the source coils have three phases, and the source coils for the respective phases have an identical shape and an identical number of turns,
the source coils are arranged at regular intervals in the extension direction, and
the source capacitor connected to the central source coil of the source coils arranged in the extension direction has a capacitance smaller than the capacitances of the other source capacitors.

10. The power transmission device according to claim 6, wherein
the capacitances of the source capacitors are set based on the inter-coil distances, and the shapes and the numbers of turns of the source coils for the respective phases.
